(19) United States
(12) Patent Application Publication
(10) Pub. No.: US 2011/0302029 A1
(43) Pub. Date: Dec. 8, 2011

(54) Interactive Business Promotion System

(76) Inventor: Randall Blair Harmon, Tucson, AZ (US)

(21) Appl. No.: 13/212,160

(22) Filed: Aug. 17, 2011

Related U.S. Application Data
(63) Continuation-in-part of application No. 12/221,896, filed on Aug. 6, 2008, now abandoned.
(60) Provisional application No. 60/963,358, filed on Aug. 6, 2007.

(51) Int. Cl. G06Q 30/00; G06F 17/30

(52) U.S. Cl. 705/14.49

(57) ABSTRACT

A system and method for an interactive multi-media business listing delivery for use by businesses and customers, includes a geographically based database with fixed input attributes and terms, and a non-geographically based information set with fixed input characteristics and labels. A multi-media component business listing is produced with a plurality of media components from a business owner that has the geographically based fixed input term and attribute and the non-geographically based fixed input label and characteristic. Wherein a customer executes a query that selectively inputs a geographically based fixed input attribute and input term plus selectively inputs a non-geographically based fixed input characteristic and label, all as matched to the business owner geographically based fixed attribute and term plus the non-geographically based selected fixed input characteristic and label. Wherein this results in a specific multi-media component business listing being delivered to the customer per the customer query.

### RELATED PATENT APPLICATIONS

This is a continuation in part (CIP) patent application claiming priority from U.S. patent application Ser. No. 12/221,896 filed on Aug. 6, 2008 by Randall Blair Harmon of Tucson, Ariz., U.S. that claims priority from U.S. provisional patent application Ser. No. 60/963,358 filed on Aug. 6, 2007 by Randall Blair Harmon of Tucson, Ariz., U.S.

### FIELD OF THE INVENTION

The present invention generally relates to internet based business directory systems for the gathering together of information that is grouped by various criteria that can prove useful to a consumer or user of that information with a minimal amount of effort from the consumer. More particularly, the present invention presents a multi-media information delivery system to give a consumer a more complete impression of business offerings in their local region and the system facilitates the businesses to have complete discretion over their offerings in so for as multi-media content and specials to entice consumers.

### DESCRIPTION OF THE RELATED ART

When looking to procure services consumers currently typically start on-line at GOOGLE, YAHOO, BING, or a similar type internet search engine service and by entering free form keyword(s)s that are close to what the consumer is looking for, the consumer will obtain a massive number of search results, wherein the overwhelming majority of these search results are inapplicable to the consumer's needs. As an example in a search for “Mexican Food” on GOOGLE, returned were 38,200,000 results which roughly amounts to almost 2,000,000 pages of results based upon 20 results per page. Meaning that with the incredibly large number of results of which at most about 20-60 results will be viewed by the consumer, i.e. 1-3 pages of results will be looked at for the most, part meaning that a huge majority of the results are completely unknown or a waste of resources. Further, the results on these first three pages or so, are just cryptic snippets of information related to each result, typically with a title line and then a few key words in description, usually without pictures, videos, addresses, phone number, emails, or other contact information, which then requires the consumer to click on the link which usually goes to a website, in the above case the main website of a Mexican Food Restaurant Chain, which will require the consumer to navigate through this website to find a “store locator” and then further to enter their location information to find a restaurant near them geographically. This does get the job done in finding a close Mexican Restaurant, however, requiring many steps from the consumer to find this information, also the priority at which search results are displayed say for the first 60 hits out of the 38,200,000 hits really is unrelated to the consumer key word search, it is based upon in part how much advertisers pay for the privilege of coming up high in the search priority rankings, thus the consumer is given search results based upon high expenditures by companies-not by what the consumer wants. The remaining portion of the search results which could be termed non-advertiser or organic results are also not based on the consumer desires, as these search rankings are based upon the search engines proprietary criteria-that are at least in part based on levels on internet activity (both negative and positive) of a particular website.

Of course there is motivation to “game” the organic results by businesses who reverse engineer the proprietary search ranking criteria to tailor their websites to just show what the search engine is looking for, in an effort to be in that highly desired first 20 or so search results, wherein these top organic search results are typically only companies who “gamed” the search engine the best, again having no relation to the consumer's desires. There have been cases of high levels of negative activity (such as negative reviews) driving a website to the first 20 search results-this obviously is not in the consumer's best interest. The bottom line is that the consumer search results on the above referenced search engines are of at best mediocre quality-by not only showing results in line with the consumer's desires, but even worse as what the consumer gets as the top ranking results (the first 60 results or so) are reflective of either who spent the most money in advertising or who “gamed” the search engine the best, also the search engines may not display at all-some results related to the consumer's key search words due to competitive reasons, or their “deep-sixing” i.e. blocking from showing a particular website for issues the search engine had with this particular website in the past.

So, the search results that the consumer gets from the above referenced search engines are incomplete, skewed to favor various websites for reasons unrelated to the consumer needs, and require extra time and keystrokes/mouse clicks for the consumer to dig down to find their desired information.

Looking at the prior art in this area starting with the United States patent application publication number US2010/0211489 A1 to Zhang et al., disclosed is a content management and delivery system that includes a plurality of communication devices and a content server, wherein each of the communication devices has a display screen for enabling haptic user interaction with data displayed therein. In Zhang, the content server causes to display a set amount of information that seeks a user interaction with a response transmitted to back to the content server. In Zhang the set amount of information is typically unique to a hotel setting, with the information including information, services, and advertisements that pertain to the interests of the user based upon their location and various tourism research that do not require the processing of a search request using keywords input by the user. Zhang is essentially an in-house Local Area Network system to facilitate more accurate and efficient information exchange between hotel staff and guests, the information offered on the communication devices is fixed by the hotel administrator, wherein the hotel guests or users simply have a choice of what to pick from the fixed grouping of information-as this is the limit of the user interaction of the system at the communication device, thus there in no uploading of any user generated content into the communication device, the user simply picks from a fixed listing of offerings.

Continuing in the prior art, United States patent application publication number US2008/0242317 A1 to Abhyanker that discloses a system for mobile content creation in a geo-spatial environment wherein the location of a mobile device is communicated to a server periodically, wherein automatically generating in the mobile device from the server adjacent profiles as being a direction away from the present geographic location of the mobile device, basically giving an enhanced map of the user immediate surroundings. Abhyanker has the capability to allow mobile device user updates of their immediate surroundings in a wiki interface that allows collaboration by many users to constantly improve the geographical database information.

Continuing in the prior art in U.S. Pat. No. 7,231,405 B2 to Xia disclosed is a method and apparatus for indexing web pages geographically based on user location, using a search engine that finds a geocoded web page that allows geographically oriented searching for web pages. Thus Xia facilitates finding a specific food type restaurant in a particular geographic location, however, there is no teaching of the user interacting to upload content for a particular listing. Further in the prior art in U.S. Pat. No. 6,282,540 B1 to Goldensher et al., disclosed is a method and apparatus for proximity searching, via using a plurality of regions that are indexed with a population of points in the regions are that are textually keyed, wherein attributes are determined corresponding to a subset of points with bitmaps assigned to the attributes and regions with the attributes and bitmaps stored in an index with the bitmap searched to identify relevant regions. Goldensher accomplishes a like function to Xia via a different method and has no teaching of the user interacting to upload content for a particular listing. Next in the prior art in U.S. Pat. No. 7,240,049 B2 to Kapur discloses a search wherein queries are parsed into tokens that are related to concept networks, wherein using trend analysis in sorting the search queries into subsets along a dimension of interest and comparing concept networks for different subsets, for instance to separate a search inquiry into a geographical location and a particular subset within the geographical location. Again, Kapur is a more sophisticated search engine, however, not teaching user uploaded content.

Moving ahead in the prior art in U.S. Pat. No. 7,243,129 B1 to Thomas discloses a method and apparatus for customization of information content using anonymous demographic data wherein one particular use would be to direct banner ads to specific users or altering the web page content to also be specific to the user via obtaining demographic information about the user of a specific computer. The demographic data in Thomas would include gender, age, marital status, salary, children, job type location, politics, hobbies, interests, and the like to enable serving up web pages attuned to the user's specific demographics, although a problem with this type of system is that a computer could have multiple users which would introduce a degree of error in the demographic data. Further Thomas teaches against user uploaded content as the purpose in Thomas is to have anonymous content information. Next, in U.S. Pat. No. 7,240,052 B2 to Sidlosky et al., discloses search query refinement based on information stored on a local storage medium, wherein a user performs a keyword/phrase search on a local computer that in turn determines a keyword/phrase search on the web, with the goal of returning links to websites of interest. Again, Sidlosky does not teach user uploaded content or search results that contain anything more than links to other websites.

Further, in the prior art, in U.S. Pat. No. 6,269,361 B1 to Davis et al., that discloses a system for influencing a search result position that includes a search term, description. and bid amount, wherein the search rank value of the bid amount is continuously updated for changing search rank positions. Davis, has a provision to track retrieval requests which results in debits to the bid account, so as bids move up and down and the bid accounts change the search rankings are in constant flux. The Davis system can have a problem with what is called “click through fraud” wherein retrievals can be manipulated to over debit the bid account and also offers are solely based upon bid value, which may not be in the searcher's best interests, also there is no teaching of uploading user content or multi-media search results. Continuing, in U.S. Pat. No. 6,078,866 to Buck et al., disclosed is an internet search site listing service based on monetary rankings, using the title and content of a specific site is ranked according to the amount of a subscription fee, with this system being similar to Davis except that Buck does not have account debits based upon retrieval requests, wherein the search ranking of the web listing is based solely on the subscription fee, which can eliminate the previously described problem of click through fraud. Buck has a lot of the same issues as Davis in that search results are solely based upon monetary subscription value, which may not be in the searcher's best interests, also there is no teaching of uploading user content or multi-media search results as the listings are the traditional title and short text phrases only. Also, in U.S. Pat. No. 6,271,840 to Finseth et al,. disclosed is a graphical search engine visual index, wherein in addition to the standard search results of a link having a title and a snippet of text (which is minimally useful), a thumbnail graphical summary with accompanying website links is also included to better enhance the search results. Noting that Finseth, again does not teach uploading of user content, however, recognizing the issue of some multi-media search results being of more use to the searcher.

The present invention addresses these needs of improving the user efficiency of searches, wherein the current systems as previously described provide cryptic snippets of information as search results that require the user to “drill down” the links into websites and to further navigate through these websites to find what they want-as the current typical search engine merely refers the user to links that may contain related information resulting in an inefficient way to find specific information, further the number of links that the typical search engine comes up with, usually in the millions-is nonsensical as no one is going to look at more than 20-60 links anyway. In addition, keyword searching is also inefficient in that words alone are not always an effective way to describe what the searcher/user is looking for, in area where the user is searching for a particular chemical compound or specific electrical term-key word searching can be efficient, due to the fact that “field or art” specific words (or lexicon) are utilized-like the name of a particular chemical, however, in more general areas wherein multiple words can be used to describe the same item-such as a bicycle could be called; velo, velocipede, bike, bicycle, two wheeler, wheels, etc. word searching becomes much less efficient thus causing a large number of inapplicable search results which is wasteful. Thus a better system is to search via categories or classes or goods and services, that way more specific results are obtained with much less inappropriate search results-resulting in a more usable search result for the user.

In accordance, with obtaining more specific or better fitting search results, the results that are displayed should be enough to tell the whole story or provide complete enough information to the user such that the user does not need to link to added websites and further to navigate through those websites, in other words-enough of a multimedia presentation is made within the primary search result itself, to give the user everything they want to know with additional searching. The present invention helps solve these two current search problems of inappropriate results and the results themselves that are considerably shy of information-requiring added “drill-down” through added websites and page navigations, by using category or attribute search classes and presenting each search result as a complete multi-media grouping of result information-meaning that the user should find out what they want to know solely from the initially displayed search result.

### SUMMARY OF INVENTION

Broadly, the present invention is of an interactive multi-media business listing delivery system, that for use by a business owner and a potential customer, the system includes a geographically based database with a plurality of geographically based fixed input attributes, wherein each fixed input attribute has at least one fixed input term, also included is a non-geographically based information set including a plurality of non-geographical based fixed input characteristics, wherein each fixed input characteristic has at least one fixed input label. Further included in the interactive multi-media business listing delivery system is one or more processors, memory, and one or more programs, wherein the one or more programs are stored in the memory and configured to be executed by one or more of the processors.

One or more of the programs includes instructions for producing a multi-media component business listing comprised of a plurality of media components created by content that includes the plurality of media components from the business owner that also has at least one geographically based fixed input term as a fixed attribute and at least one non-geographically based fixed input label as a fixed characteristic. Further program instructions include instructions for associating the plurality of non-geographical based fixed input characteristics in accordance with the fixed input labels with the plurality of geographically based fixed input attributes in accordance with the fixed input terms. Wherein the potential customer executes a query that selectively inputs a geographically based fixed input attribute with a selected fixed input term and selectively inputs a non-geographically based fixed input characteristic with a selected fixed input label, all as matched to the business owner geographically based said selected fixed attribute and said selected fixed input term and the non-geographically based selected fixed input characteristic and the selected fixed label. Wherein this results in a specific multi-media component business listing being delivered to the potential customer per the potential customer query.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a diagrammatic flow chart of the interactive multi-media business listing delivery system with the geographic database, the non-geographic information set, the processor, the memory, the programs, the potential customer, the business owner, the multi-media component business listings, and the display of the specific multi-media component business listing;

FIG. 2 shows a diagrammatic flow chart of the computer readable storage medium having stored instructions to cause a machine to perform the method of delivering the multi-media business listing with the geographic database, the non-geographic information set, the potential customer, the business owner, the multi-media component business listings, and the display of the specific multi-media component business listing;

FIG. 3 shows a simplified screen shot on the landing page for the seeingit.com domain that shows the non-geographical based fixed input characteristics, the fixed input labels, the geographical based input attributes, the fixed input terms, the multi-media business listing with the media components; and

FIG. 4 shows a block flow chart of the computer based method for delivering a multi-media business listing for use by a business owner and a potential customer, starting with uploading a selected plurality of media components, inputting at least one geographically based attribute and term, also inputting at least one non-geographically based input characteristic and label, keying in a query for a geographically based attribute and term, and further keying in the non-geographically based fixed input characteristic and label, also displaying the multi-media business listing to the potential customer by comparing geographical attributes and terms plus non-geographical characteristics and labels, all as matched as between the business owner and the potential customer.

### REFERENCE NUMBERS IN DRAWINGS

50 Interactive multi-media business listing delivery system

55 Business owner

60 Potential customer

65 Geographically based database

70 Attribute of geographically based database 65

75 Term of geographically based database 65

80 Non-geographically based information set

85 Characteristic of non-geographically based information set 80

90 Label of non-geographically based information set 80

95 One of more processors

100 Memory

105 One or more programs

110 Multi-media component business listing

115 Media components of the multi-media component business listing 110

120 Computer readable storage medium

125 Machine

130 Computer

135 Method for delivering a multi-media business listing 110

140 Uploading a selected plurality of media components 115

145 Inputting selectively at least one geographically based attribute 70 and term 75 and at least one non-geographically based characteristic 85 and label 90

150 Keying in a selective query for one geographically based attribute 70 and term 75 and at least one non-geographically based characteristic 85 and label 90

155 Displaying the multi-media business listing 110 to the potential customer 60 based upon their search query 150

### DETAILED DESCRIPTION

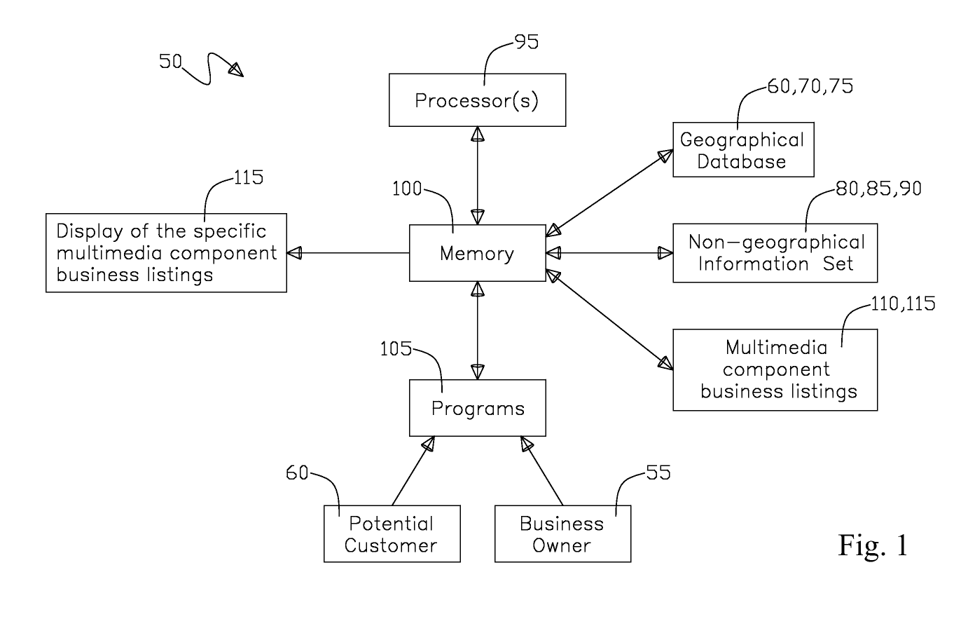

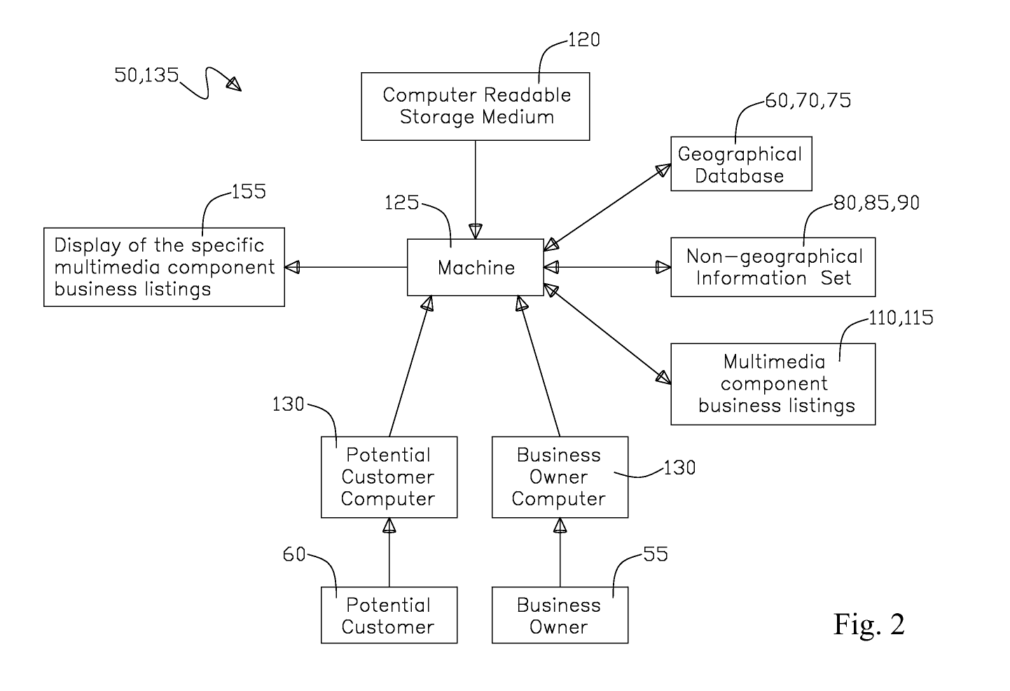

With initial reference to FIG. 1 shown is a diagrammatic flow chart of the interactive multi-media business listing delivery system 50 with the geographic database 65, the non-geographic information set 80, the processor 95, the memory 100, the programs 105, the potential customer 60, the business owner 55, the multi-media component business listings 110, and the display 155 of the specific multi-media component business listing. Next, FIG. 2 shows a diagrammatic flow chart of the computer readable storage medium 120 having stored instructions to cause a machine 125 to perform the method 135 of delivering the multi-media business listing 110 with the geographic database 65, the non-geographic information set 80, the potential customer 60, the business owner 55, the multi-media component business listings 110, and the display 155 of the specific multi-media component business listing 110.

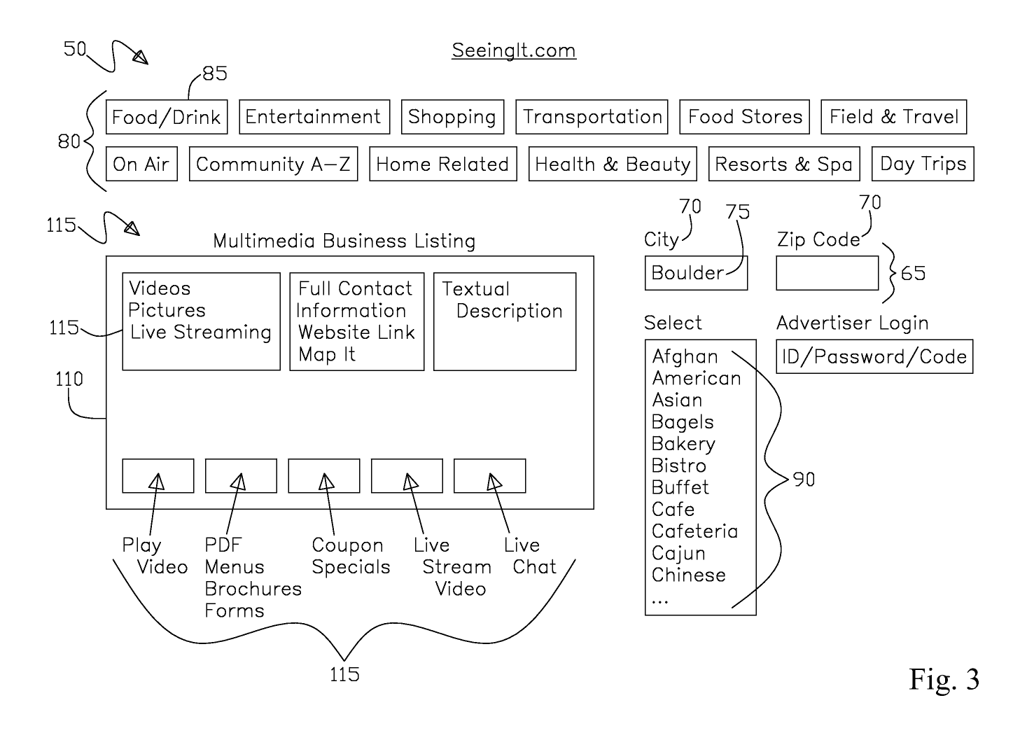

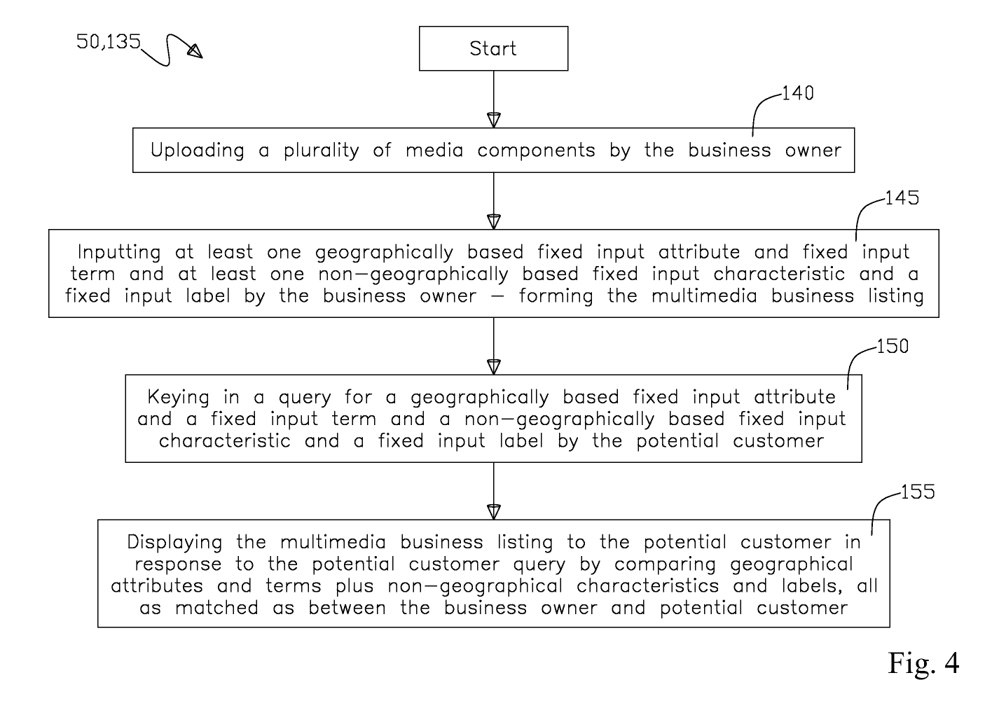

Continuing, FIG. 3 shows a simplified screen shot on the landing page for the seeingit.com domain that shows the non-geographical based fixed input characteristics 85, the fixed input labels 90, the geographical based input attributes 70, the fixed input terms 75, the multi-media business listing 110 with the media components 115. Further, FIG. 4 shows a block flow chart of the computer based method 135 for delivering a multi-media business listing 110 for use by a business owner 55 and a potential customer 60, starting with uploading a selected plurality of media components 115, inputting at least one geographically based attribute 70 and term 75, also inputting at least one non-geographically based input characteristic 85 and label 90, keying in a query 150 for a geographically based attribute 70 and term 75. FIG. 4 also shows further keying in the non-geographically based fixed input characteristic 85 and label 90, and displaying 155 the multi-media business listing 110 to the potential customer 60 by comparing geographical attributes 70 and terms 75 plus non-geographical characteristics 85 and labels 90, all as matched as between the business owner 55 and the potential customer 60.

Broadly, the present invention is of an interactive multi-media business listing delivery system 50, that for use by a business owner 55 and a potential customer 60, the system 50 includes a geographically based database 65 including a plurality of geographically based fixed input attributes 70, wherein each fixed input attribute 70 has at least one fixed input term 75. Also included in the interactive multi-media business listing delivery system 50, is a non-geographically based information set 80 including a plurality of non-geographical based fixed input characteristics 85, wherein each fixed input characteristic 85 has at least one fixed input label 90. Further included in the interactive multi-media business listing delivery system 50 is one or more processors 95, memory 100, and one or more programs 105, wherein the one or more programs 105 are stored in the memory 100 and configured to be executed by one or more of the processors 95, as best shown in FIG. 1.

One or more of the programs 105 includes instructions for producing a multi-media component 115 business listing 110 comprised of a plurality of media components 115 created by content that includes the plurality of media components 115 from the business owner 55 that also has at least one geographically based fixed input term 75 as a fixed attribute 70 and at least one non-geographically based fixed input label 90 as a fixed characteristic 85. Further program 105 instructions include instructions for associating the plurality of non-geographical based fixed input characteristics 85 in accordance with the fixed input labels 90 with the plurality of geographically based fixed input attributes 70 in accordance with the fixed input terms 75. Wherein the potential customer 60 executes a query that selectively inputs a geographically based fixed input attribute 70 with a selected fixed input term 75 and selectively inputs a non-geographically based fixed input characteristic 85 with a selected fixed input label 90, all as matched to the business owner 55 geographically based said selected fixed attribute 70 and said selected fixed input term 75 and the non-geographically based selected fixed input characteristic 85 and the selected fixed label 90. Wherein, this results in a specific multi-media component business listing 110 being delivered to the potential customer 60 per the potential customer 60 query 150, as best shown in FIGS. 1 and 4.

Further, on the interactive multi-media business listing delivery system 50, the media components 115 are preferably selected from the group consisting essentially of images, image slide shows, videos, live streaming videos, portable document formats, coupons, live chats, business name header, business textual description, business address, business phone number, business fax number, business email, business address map link, and business website link, all as best shown in FIG. 3. In addition, for the interactive multi-media business listing delivery system 50, the geographically based fixed input attributes 70 are preferably selected from the group consisting essentially of zip codes, street addresses, city names, county names, state names, and geographic feature descriptors, again as best shown in FIG. 3. In so far as the geographic feature descriptors, these would include local metaphors or nicknames that are associated with geographic features or are just a name associated with an area such as; panhandle, peninsula, Dixie, inlet, rocky, desert, island, riverfront, mountain, Oceanside, and the like.

Next, for the interactive multi-media business listing delivery system 50 the non-geographical based fixed input characteristics 85 are preferably selected from the group consisting essentially of food & drink, entertainment, shopping, transportation, food stores, hotels & travel, live streaming video, community, home, health & beauty, resorts & spas, and day trips, all as best seen in FIG. 3. Continuing, for the interactive multi-media business listing delivery system 50 the non-geographical based fixed input characteristic 85 of food & drink includes fixed input labels 90 preferably selected from the group consisting essentially of Afghan, American, American Fusion, Asian, Bagels, Bakery, Barbeque, Bistro, Brew Pub, Buffet, Cafe, Cafeteria, Cajun, Chinese, Coffeehouse, Continental, Creole, Delicatessen, Desserts, Diner, Doughnuts, English Pub, Ethiopian, Farmers Market, Fast Food, Fondue, French, German, Gourmet, Greek, Hawaiian, Hot Wings, Indian, Irish Pub, Italian, Japanese, Korean, Kosher, Latin, Lounge, Mediterranean, Mexican, Pizza, Polynesian, Provencal, Salad & Sandwich, Salad Bar, Saloon, Seafood, Southwest, Sports Bar, Steakhouse, Subs & Sandwiches, Sushi Bar, Tavern, Tea Room Cafe, Thai, Vegetarian, Vineyard, Wine Bar, and Wine Tasting, also as best shown in FIG. 3. It can be seen that searching or creating queries by the potential customer 60 using these fixed characteristics 85, labels 90, attributes 70, and terms 75 makes search fast easy and more precise that conventional open word searching, giving the potential customer 60 what they want immediately, as opposed a GOOGLE or other mainstream search that returns millions of search results that are not useful, wherein the GOOGLE searcher typically would only view a dozen or so search results anyway, that are typically only remotely specific to the searchers inquiry.

Further, the interactive multi-media business listing delivery system 50 presents a multi-media component business listing 110 that is complete on its face within itself, thus the searcher or potential customer 60 knows from just viewing the search result alone, whether it is useful or not, thus not requiring the searcher to keep clicking on links in going to other websites-that they themselves have to be navigated through, causing added time and frustration for the searcher, such as with the results of a GOOGLE search that gives a few cryptic lines of text that typically require the searcher to click on additional links and do additional outside website navigation. As an example with the present invention of the interactive multi-media business listing delivery system 50, the potential customer 60 would see a screen similar to FIG. 3 after going to the www.seeingit.com website, and could selectively click on the fixed non-geographic characteristic 85 of “Food & Drink”, in other words no freely open text to input (as in GOOGLE), simply a fixed characteristic to choose from, next the potential customer 60 can select a non-geographic fixed label 90, for instance “Asian”, next the potential customer 60 would select a fixed geographic attribute 70 such as “city” and then select the geographically fixed term 75 of “Boulder” and then initiate the search with a specific result of a multi-media component business listing 110 that has a complete set of multi-media components 115, thus giving the potential customer 60 a full information set on their specific search result being the multi-media component business listing 110, without the need for sifting through numerous irrelevant search results that have to be clicked through to added websites that need to be navigated therethrough. The same search on GOOGLE for “Boulder Asian Restaurants” produced 1,840,000 results-of course proving that many of the results are irrelevant-there are not 1,840,000 Asian Restaurants in Boulder, Colo., and further a number of the results simply give websites to go to, or added outside directories that have to searched themselves, or just a restaurant name, phone, and address, wherein neither the phone or address are linked to making a computer call or a map respectively, however, usually no other information is supplied, further the search results in GOOGLE are not in any type of standardized format for finding desired information without clicking the links and further navigating additional websites which is inefficient.

With the present invention interactive multi-media business listing delivery system 50 for the multi-media component business listing 110—there is a plethora of information available in a standardized format, as shown in FIG. 3, including images, image slide shows, videos, live streaming videos, portable document formats, coupons, live chats, business name header, business textual description, business address, business phone number, business fax number, business email, business address map link, and business website link, virtually telling the potential customer 60 everything they would need to know, with at most a single click to a restaurant menu for instance, as opposed to clicking on a restaurant website and then having to navigate to find a menu, if possible. Also, the business owner 55 can create and/or update their multi-media component business listing 110 anytime with the business owners 55 self generated content, making their listing 110 totally within their control, for ads, specials, live video, and the like.

Also, for the interactive multi-media business listing delivery system 50 the media components 115 can be bookmarked and shared as links to external internet locations, wherein for example of a video that as a media component 115, the video is generated or converted into a link address being an internet uniform resources locator (URL) for example; www.seeingit.com/AdvertiserVideo.aspx?shva=2668 that can be posted to an external website such as FACEBOOK, thereby increasing internet exposure in an individual's FACEBOOK page, or their business FACEBOOK page, and the like, wherein the FACEBOOK link would be for example; www.facebook.com/buylocalnow. Thus facilitating multiple exposure to additional potential customers 60 for that particular media component 115 for the business owner 55.

In addition, for the interactive multi-media business listing delivery system 50 the media component 115 of coupons can be automatically generated in the form of a printable sheet and tracked for transactions as between the potential customer 60 and the business owner 55. As an example, the potential customer 60 inputs the address attribute 70 term 75 of for instance a particular hotel that currently has a multi-media component business listing 110 and the potential customer 60 inputs their own address, there can be a way to track the potential customer 60 spending, as well as providing the opportunity for a loyalty awards program as between the particular customer 60 and that business listing 110. The media component 115 coupon can automatically generate the business owner 55 media component 115 of a business address and the potential customer 60 address on the media component 115 coupon and/or a dedicated code for tracking the potential customer 60 activity with the business owner 55, when the potential customer 60 enters a database including their email and address to be in a potential customer 60 database that allows an anonymous potential customer 60 identifier.

Continuing, for the interactive multi-media business listing delivery system 50 for the non-geographical based fixed input characteristic 85 of entertainment includes fixed input labels 90 preferably selected from the group consisting essentially of Amusement Parks, Arenas, Art Galleries, Ballooning, Baseball Parks, Bicycle Rentals, Biking Trails, Boating, Botanic Gardens, Bowling, Casino, Dinner Theatres, Exhibits, Family Fun, Glider Rides, Golf, Helicopter Rides, Hiking Trails, Horseback Rides, Museums, Nightclubs, Observatories, Parks, Rafting & Kayaks & Canoes, Skate Parks, Ski Resorts, Soccer, Stadiums, Theaters, Tour Operators, Water Parks, and Zoos, which would be shown in FIG. 3 if the “Entertainment” characteristic 85 was selected, as what is shown in FIG. 3 is the “Food & Drink” characteristic 85 for the labels 90.

Next, on the interactive multi-media business listing delivery system 50 for the non-geographical based fixed input characteristic 85 of shopping includes fixed input labels 90 preferably selected from the group consisting essentially of Antique Dealers, Appliances, Art Dealers, Audio, Bookstores, Boutiques, Casual Clothing, Cell Phones, Drug Stores, Electronics, Factory Outlets, Fashion Clothing, Feed & Supply, Florists, Furniture Dealers, Hardware, Home Goods, Jewelers & Watches, Jewelry & Watch Repair, Novelties, Nurseries, Perfumes, Shoe Repair, Shoes, Shopping Malls, Specialty Retainers, Sporting Goods, Thrift Stores, and Urban Shopping & Dining Destinations, which would be shown in FIG. 3 if the “Shopping” characteristic 85 was selected, as what is shown in FIG. 3 is the “Food & Drink” characteristic 85 for the labels 90.

Further, for the interactive multi-media business listing delivery system 50 for the non-geographical based fixed input characteristic 85 of transportation includes fixed input labels 90 preferably selected from the group consisting essentially of Airport Shuttles, Auto Accessories, Auto Dealers, Auto Parts, Auto Repair, Car Washes, Detailing, For Sale by Owner, Insurance, Limousine, Motorcycle Dealers, Motorcycle Repair, Movers, Public Transportation, Rental Cars, RV/Boat Storage, Storage Lockers, Taxis, and Towing, which would be shown in FIG. 3 if the “Transportation” characteristic 85 was selected, as what is shown in FIG. 3 is the “Food & Drink” characteristic 85 for the labels 90.

Continuing, for the interactive multi-media business listing delivery system 50 for the non-geographical based fixed input characteristic 85 of food stores includes fixed input labels 90 selected from the group consisting essentially of Ethnic, Farmers Markets, Food Coops, Grocers, Health Foods, Markets, Organic Markets, and Pet Food, which would be shown in FIG. 3 if the “Food Stores” characteristic 85 was selected, as what is shown in FIG. 3 is the “Food & Drink” characteristic 85 for the labels 90.

Moving onward, for the interactive multi-media business listing delivery system 50 for the non-geographical based fixed input characteristic 85 of hotels & travel includes fixed input labels 90 selected from the group consisting essentially of Air Charters, Airlines, Bed & Breakfasts, FBO's-Fixed Base Operators, Hotels, RV Parks, Tour Operators, and Travel Agents, which would be shown in FIG. 3 if the “Hotels & Travel” characteristic 85 was selected, as what is shown in FIG. 3 is the “Food & Drink” characteristic 85 for the labels 90.

Yet further, for the interactive multi-media business listing delivery system 50 for the non-geographical based fixed input characteristic 85 of on air includes fixed input labels 90 selected from the group consisting essentially of Astrology TV, Auto Shows, Citizen Journalism, Employment Shows, Food Shows, How-to-Shows, Indie Films, Live Bands, Local News Shows, Motorcycle Shows, Music & Arts, Networking Events, Out on the Town, Radio Stations, Special Events, Special Interests, Sports Shows, Talk Radio, Television Stations, Travel Shows, Webcams, and Webcasts, which would be shown in FIG. 3 if the “On Air” characteristic 85 was selected, as what is shown in FIG. 3 is the “Food & Drink” characteristic 85 for the labels 90.

Next, for the interactive multi-media business listing delivery system 50 for the non-geographical based fixed input characteristic 85 of community a-z includes fixed input labels 90 selected from the group consisting essentially of Advertising Agencies, Advocacy, Animal Shelters, Assisted Living, Attorneys, Banking, Business Associations, Business Consultants, Business Services, Child Care, Churches, Clubs & Organizations, Collection Agencies, Convention & Visitors Bureaus, Economic Development, Employment Agencies, Financial Services, Financial & Business Planning, Garage Sales, Government Offices, Graphic Design, Home & Commercial Security, Hospital, Insurance, Newspaper, Pet Groomers, Photography & Video Production, Printing Services, Public Library, School, Storage Lockers, Veterinarians, Virtual 360 Tour Photography, and Website Design, which would be shown in FIG. 3 if the “Community A-Z” characteristic 85 was selected, as what is shown in FIG. 3 is the “Food & Drink” characteristic 85 for the labels 90.

Continuing, for the interactive multi-media business listing delivery system 50 for the non-geographical based fixed input characteristic 85 of home related includes fixed input labels 90 selected from the group consisting essentially of Apartments, Appraisers, Architects, Building Contractors, Condo Rentals, Electrical, Finance, Flooring, For Sale by Owner, Heating & Cooling, Home for Sale, Home Improvement, Home Rental, Home Repair, Landscape Services, Management Services, Mobile Home Parks, Mortgage, New Home Community, Open Houses, Painters, Pest Control, Plumbers, Pools & Spas, Realtors, Remodeling, Storage Lockers, Storage Lockers & Temperature Controlled Units, Virtual 360 Tour Photography, and Windows & Blinds, which would be shown in FIG. 3 if the “Home Related” characteristic 85 was selected, as what is shown in FIG. 3 is the “Food & Drink” characteristic 85 for the labels 90.

Further, for the interactive multi-media business listing delivery system 50 for the non-geographical based fixed input characteristic 85 of health and beauty includes fixed input labels 90 selected from the group consisting essentially of Alternative Medicine, Chiropractic Care, Dentists, Gym & Health Clubs, Hair Salons, Labs, Martial Arts & Fitness, Massage Therapy, Nail Salons, Nutritionists, Optometrists, Personal Trainers, Physicians, Skincare-Aesthetics, and Tattoo's, which would be shown in FIG. 3 if the “Health & Beauty” characteristic 85 was selected, as what is shown in FIG. 3 is the “Food & Drink” characteristic 85 for the labels 90.

Moving ahead, for the interactive multi-media business listing delivery system 50 for the non-geographical based fixed input characteristic 85 of resorts & spas includes fixed input labels 90 selected from the group consisting essentially of Day Spas, Guest Ranches, Medical Day Spas, Resorts, and Wellness Centers, which would be shown in FIG. 3 if the “Resorts & Spas” characteristic 85 was selected, as what is shown in FIG. 3 is the “Food & Drink” characteristic 85 for the labels 90. Next, for the interactive multi-media business listing delivery system 50 for the non-geographical based fixed input characteristic 85 of day trips includes fixed input labels 90 selected from the group consisting essentially of Circle Tours, Historic Places, Monuments, National Parks, Nature Preserves, Scenic Drives, State Parks, and Wine Tastings, which would be shown in FIG. 3 if the “Day Trips” characteristic 85 was selected, as what is shown in FIG. 3 is the “Food & Drink” characteristic 85 for the labels 90.

An alternate embodiment of the interactive multi-media business listing delivery system 50 would be in the form of a computer readable storage medium 120 having stored therein instructions to cause a machine 125 to perform a method 135 of delivering a multi-media business listing 110 for use by a business owner 55 and a potential customer 60, as shown diagrammatically in FIG. 2. The method 135 is in using a computer 130 for the business owner 55 to selectively enter a plurality of media components 115 selected from the group preferably consisting essentially of images, image slide shows, videos, live streaming videos, portable document formats, coupons, live chats, business name header, business textual description, business address, business phone number, business fax number, business email, business address map link, and business website link, all as shown in FIG. 3.

Subsequently, for the method 135 a next step of using a computer 130 for the business owner 55 to selectively enter least one geographically based selected fixed input attribute 70 selected from the group preferably consisting essentially of zip codes, street addresses, city names, county names, state names, and geographic feature descriptors, then followed by a selected fixed input term 75 of the attribute 70 and a non-geographically based selected fixed input characteristic 85 selected from the group preferably consisting essentially of food & drink, entertainment, shopping, transportation, food stores, hotels & travel, live streaming video, community, home, health & beauty, resorts & spas, and day trips, as shown in FIG. 3. Next a step followed by a selected fixed input label 90 of the characteristic 85, wherein the business owner 55 forms a multi-media business listing 110 from the media components 115 and the geographically based input attribute 70 and the input term 75 along with the non-geographic input characteristic 85 plus the input label 90.

Continuing for the method 135, a subsequent step of using a computer 130 for the potential customer 60 to selectively query a geographically based fixed input attribute 70 selected from the group preferably consisting essentially of zip codes, street addresses, city names, county names, state names, and geographic feature descriptors, followed by a selected fixed input term 75 of the attribute. The potential customer 60 also performs a selective query for a non-geographically based fixed input characteristic 85 selected from the group preferably consisting essentially of food & drink, entertainment, shopping, transportation, food stores, hotels & travel, live streaming video, community, home, health & beauty, resorts & spas, and day trips, followed by a selected fixed input label 90 of the characteristic 85. Further a step of delivering or displaying 155 the multi-media business listing 110 to the potential customer 60 in response to the potential customer 60 query 150 using instructions to compare the geographically based selected fixed input attribute 70 with the selected fixed input term 75 and the non-geographically based selected fixed input characteristic 85 with the selected fixed input label 90, all as matched between the business owner 55 and the potential customer 60.

Another alternate embodiment of the interactive multi-media business listing delivery system 50 would be in the form of a computer based method 135 for delivering a multi-media business listing 110 for use by a business owner 55 and a potential customer 60, as diagrammed in FIG. 4. The method 135 including the steps of uploading 140 a selected plurality of media components 115 selected from the group preferably consisting essentially of images, image slide shows, videos, live streaming videos, portable document formats, coupons, live chats, business name header, business textual description, business address, business phone number, business fax number, business email, business address map link, and business website link from the business owner, as shown in FIG. 3.

A subsequent method step 135 of inputting 145 selectively at least one geographically based selected fixed input attribute 70 selected from the group preferably consisting essentially of zip codes, street addresses, city names, county names, state names, and geographic feature descriptors, followed by a selected fixed input term 75 of the attribute 70 and at least one non-geographically based selected fixed input characteristic 85 selected from the group preferably consisting essentially of food & drink, entertainment, shopping, transportation, food stores, hotels & travel, live streaming video, community, home, health & beauty, resorts & spas, and day trips, followed by a selected fixed input label 90 of the characteristic 85 from the business owner 55. Wherein the business owner 55 forms a multi-media business listing 110 from the media components 115 and the geographically based input attribute 70 and the input term 75 along with the non-geographic input characteristic 85 plus the input label 90, all as best shown in FIG. 3.

Continuing, a next step of keying 150 in a selective query for a geographically based fixed input attribute 70 selected from the group preferably consisting essentially of zip codes, street addresses, city names, county names, state names, and geographic feature descriptors, followed by a selected fixed input term 75 of the attribute 70 by the potential customer 60, the potential customer 60 also performs a selective query for a non-geographically based fixed input characteristic 85 selected from the group preferably consisting essentially of food & drink, entertainment, shopping, transportation, food stores, hotels & travel, live streaming video, community, home, health & beauty, resorts & spas, and day trips, followed by a selected fixed input label 90 of the characteristic 85, also as best shown in FIG. 3. Further, a step of displaying 155 the multi-media business listing 110 to the potential customer 60 in response to the potential customer 60 query to compare the geographically based selected fixed input attribute 70 with the selected fixed input term 75 and the non-geographically based selected fixed input characteristic 85 with the selected fixed input label 90, all as matched between the business owner 55 and the potential customer 60.

### CONCLUSION

Accordingly, the present invention of an Interactive Multi-Media Business Listing Delivery system 50 has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. An interactive multi-media business listing delivery system, for use by a business owner and a potential customer, said system comprising:
(a) a geographically based database including a plurality of geographically based fixed input attributes, wherein each fixed input attribute has at least one fixed input term;
(b) a non-geographically based information set including a plurality of non-geographical based fixed input characteristics, wherein each fixed input characteristic has at least one fixed input label;
(c) one or more processors;
(d) memory; and
(e) one or more programs, wherein said one or more programs are stored in said memory and configured to be executed by said one or more processors, said one or more programs including:
(e)(i) instructions for producing a multi-media component business listing comprised of a plurality of media components created by content that includes said plurality of media components from the business owner that also has at least one geographically based fixed input term as a fixed attribute and at least one non-geographically based fixed input label as a fixed characteristic; and
(e)(ii) instructions for associating said plurality of non-geographical based fixed input characteristics in accordance with said fixed input labels with said plurality of geographically based fixed input attributes in accordance with said fixed input terms, wherein the potential customer executes a query that selectively inputs a geographically based fixed input attribute with a selected fixed input term and selectively inputs a non-geographically based fixed input characteristic with a selected fixed input label, all as matched to the business owner geographically based said selected fixed attribute and said selected fixed input term and said non-geographically based selected fixed input characteristic and said selected fixed label, resulting in a specific multi-media component business listing delivered to the potential customer per the potential customer query.

2. An interactive multi-media business listing delivery system according to claim 1 wherein said media components are selected from the group consisting essentially of images, image slide shows, videos, live streaming videos, portable document formats, coupons, live chats, business name header, business textual description, business address, business phone number, business fax number, business email, business address map link, and business website link.

3. An interactive multi-media business listing delivery system according to claim 2, wherein said media components can be bookmarked and shared as links to external internet locations.

4. An interactive multi-media business listing delivery system according to claim 2, wherein said coupons can be automatically generated and tracked for transactions as between the potential customer and the business owner.

5. An interactive multi-media business listing delivery system according to claim 2 wherein said geographically based fixed input attributes are selected from the group consisting essentially of zip codes, street addresses, city names, county names, state names, and geographic feature descriptors.

6. An interactive multi-media business listing delivery system according to claim 2 wherein said non-geographical based fixed input characteristics are selected from the group consisting essentially of food & drink, entertainment, shopping, transportation, food stores, hotels & travel, live streaming video, community, home, health & beauty, resorts & spas, and day trips.

7. An interactive multi-media business listing delivery system according to claim 6 wherein said non-geographical based fixed input characteristic of food & drink includes fixed input labels selected from the group consisting essentially of Afghan, American, American Fusion, Asian, Bagels, Bakery, Barbeque, Bistro, Brew Pub, Buffet, Cafe, Cafeteria, Cajun, Chinese, Coffeehouse, Continental, Creole, Delicatessen, Desserts, Diner, Doughnuts, English Pub, Ethiopian, Farmers Market, Fast Food, Fondue, French, German, Gourmet, Greek, Hawaiian, Hot Wings, Indian, Irish Pub, Italian, Japanese, Korean, Kosher, Latin, Lounge, Mediterranean, Mexican, Pizza, Polynesian, Provencal, Salad & Sandwich, Salad Bar, Saloon, Seafood, Southwest, Sports Bar, Steakhouse, Subs & Sandwiches, Sushi Bar, Tavern, Tea Room Cafe, Thai, Vegetarian, Vineyard, Wine Bar, and Wine Tasting.

8. An interactive multi-media business listing delivery system according to claim 6 wherein said non-geographical based fixed input characteristic of entertainment includes fixed input labels selected from the group consisting essentially of Amusement Parks, Arenas, Art Galleries, Ballooning, Baseball Parks, Bicycle Rentals, Biking Trails, Boating, Botanic Gardens, Bowling, Casino, Dinner Theatres, Exhibits, Family Fun, Glider Rides, Golf, Helicopter Rides, Hiking Trails, Horseback Rides, Museums, Nightclubs, Observatories, Parks, Rafting & Kayaks & Canoes, Skate Parks, Ski Resorts, Soccer, Stadiums, Theaters, Tour Operators, Water Parks, and Zoos.

9. An interactive multi-media business listing delivery system according to claim 6 wherein said non-geographical based fixed input characteristic of shopping includes fixed input labels selected from the group consisting essentially of Antique Dealers, Appliances, Art Dealers, Audio, Bookstores, Boutiques, Casual Clothing, Cell Phones, Drug Stores, Electronics, Factory Outlets, Fashion Clothing, Feed & Supply, Florists, Furniture Dealers, Hardware, Home Goods, Jewelers & Watches, Jewelry & Watch Repair, Novelties, Nurseries, Perfumes, Shoe Repair, Shoes, Shopping Malls, Specialty Retainers, Sporting Goods, Thrift Stores, and Urban Shopping & Dining Destinations.

10. An interactive multi-media business listing delivery system according to claim 6 wherein said non-geographical based fixed input characteristic of transportation includes fixed input labels selected from the group consisting essentially of Airport Shuttles, Auto Accessories, Auto Dealers, Auto Parts, Auto Repair, Car Washes, Detailing, For Sale by Owner, Insurance, Limousine, Motorcycle Dealers, Motorcycle Repair, Movers, Public Transportation, Rental Cars, RV/Boat Storage, Storage Lockers, Taxis, and Towing.

11. An interactive multi-media business listing delivery system according to claim 6 wherein said non-geographical based fixed input characteristic of food stores includes fixed input labels selected from the group consisting essentially of Ethnic, Farmers Markets, Food Coops, Grocers, Health Foods, Markets, Organic Markets, and Pet Food.

12. An interactive multi-media business listing delivery system according to claim 6 wherein said non-geographical based fixed input characteristic of hotels & travel includes fixed input labels selected from the group consisting essentially of Air Charters, Airlines, Bed & Breakfasts, FBO's-Fixed Base Operators, Hotels, RV Parks, Tour Operators, and Travel Agents.

13. An interactive multi-media business listing delivery system according to claim 6 wherein said non-geographical based fixed input characteristic of on air includes fixed input labels selected from the group consisting essentially of Astrology TV, Auto Shows, Citizen Journalism, Employment Shows, Food Shows, How-to-Shows, Indie Films, Live Bands, Local News Shows, Motorcycle Shows, Music & Arts, Networking Events, Out on the Town, Radio Stations, Special Events, Special Interests, Sports Shows, Talk Radio, Television Stations, Travel Shows, Webcams, and Webcasts.

14. An interactive multi-media business listing delivery system according to claim 6 wherein said non-geographical based fixed input characteristic of community a-z includes fixed input labels selected from the group consisting essentially of Advertising Agencies, Advocacy, Animal Shelters, Assisted Living, Attorneys, Banking, Business Associations, Business Consultants, Business Services, Child Care, Churches, Clubs & Organizations, Collection Agencies, Convention & Visitors Bureaus, Economic Development, Employment Agencies, Financial Services, Financial & Business Planning, Garage Sales, Government Offices, Graphic Design, Home & Commercial Security, Hospital, Insurance, Newspaper, Pet Groomers, Photography & Video Production, Printing Services, Public Library, School, Storage Lockers, Veterinarians, Virtual 360 Tour Photography, and Website Design.

15. An interactive multi-media business listing delivery system according to claim 6 wherein said non-geographical based fixed input characteristic of home related includes fixed input labels selected from the group consisting essentially of Apartments, Appraisers, Architects, Building Contractors, Condo Rentals, Electrical, Finance, Flooring, For Sale by Owner, Heating & Cooling, Home for Sale, Home Improvement, Home Rental, Home Repair, Landscape Services, Management Services, Mobile Home Parks, Mortgage, New Home Community, Open Houses, Painters, Pest Control, Plumbers, Pools & Spas, Realtors, Remodeling, Storage Lockers, Storage Lockers & Temperature Controlled Units, Virtual 360 Tour Photography, and Windows & Blinds.

16. An interactive multi-media business listing delivery system according to claim 6 wherein said non-geographical based fixed input characteristic of health and beauty includes fixed input labels selected from the group consisting essentially of Alternative Medicine, Chiropractic Care, Dentists, Gym & Health Clubs, Hair Salons, Labs, Martial Arts & Fitness, Massage Therapy, Nail Salons, Nutritionists, Optometrists, Personal Trainers, Physicians, Skincare-Aesthetics, and Tattoo's.

17. An interactive multi-media business listing delivery system according to claim 6 wherein said non-geographical based fixed input characteristic of resorts & spas includes fixed input labels selected from the group consisting essentially of Day Spas, Guest Ranches, Medical Day Spas, Resorts, and Wellness Centers.

18. An interactive multi-media business listing delivery system according to claim 6 wherein said non-geographical based fixed input characteristic of day trips includes fixed input labels selected from the group consisting essentially of Circle Tours, Historic Places, Monuments, National Parks, Nature Preserves, Scenic Drives, State Parks, and Wine Tastings.

19. A computer readable storage medium having stored therein instructions to cause a machine to perform a method of delivering a multi-media business listing for use by a business owner and a potential customer, the method comprising:
(a) using a computer for the business owner to selectively enter a plurality of media components selected from the group consisting essentially of images, image slide shows, videos, live streaming videos, portable document formats, coupons, live chats, business name header, business textual description, business address, business phone number, business fax number, business email, business address map link, and business website link;
(b) using a computer for the business owner to selectively enter least one geographically based selected fixed input attribute selected from the group consisting essentially of zip codes, street addresses, city names, county names, state names, and geographic feature descriptors, followed by a selected fixed input term of said attribute and a non-geographically based selected fixed input characteristic selected from the group consisting essentially of food & drink, entertainment, shopping, transportation, food stores, hotels & travel, live streaming video, community, home, health & beauty, resorts & spas, and day trips, followed by a selected fixed input label of said characteristic, wherein the business owner forms a multi-media business listing from said media components and said geographically based input attribute and said input term along with said non-geographic input characteristic plus said input label;
(c) using a computer for the potential customer to selectively query a geographically based fixed input attribute selected from the group consisting essentially of zip codes, street addresses, city names, county names, state names, and geographic feature descriptors, followed by a selected fixed input term of said attribute, the potential customer also performs a selective query for a non-geographically based fixed input characteristic selected from the group consisting essentially of food & drink, entertainment, shopping, transportation, food stores, hotels & travel, live streaming video, community, home, health & beauty, resorts & spas, and day trips, followed by a selected fixed input label of said characteristic; and
(d) delivering said multi-media business listing to the potential customer in response to the potential customer query using instructions to compare said geographically based selected fixed input attribute with said selected fixed input term and said non-geographically based selected fixed input characteristic with said selected fixed input label, all as matched between the business owner and the potential customer.

20. A computer based method for delivering a multi-media business listing for use by a business owner and a potential customer, said method comprising the steps of:
(a) uploading a selected plurality of media components selected from the group consisting essentially of images, image slide shows, videos, live streaming videos, portable document formats, coupons, live chats, business name header, business textual description, business address, business phone number, business fax number, business email, business address map link, and business website link from the business owner;
(b) inputting selectively at least one geographically based selected fixed input attribute selected from the group consisting essentially of zip codes, street addresses, city names, county names, state names, and geographic feature descriptors, followed by a selected fixed input term of said attribute and at least one non-geographically based selected fixed input characteristic selected from the group consisting essentially of food & drink, entertainment, shopping, transportation, food stores, hotels & travel, live streaming video, community, home, health & beauty, resorts & spas, and day trips, followed by a selected fixed input label of said characteristic from the business owner, wherein the business owner forms a multi-media business listing from said media components and said geographically based input attribute and said input term along with said non-geographic input characteristic plus said input label;
(c) keying in a selective query for a geographically based fixed input attribute selected from the group consisting essentially of zip codes, street addresses, city names, county names, state names, and geographic feature descriptors, followed by a selected fixed input term of said attribute by the potential customer, the potential customer also performs a selective query for a non-geographically based fixed input characteristic selected from the group consisting essentially of food & drink, entertainment, shopping, transportation, food stores, hotels & travel, live streaming video, community, home, health & beauty, resorts & spas, and day trips, followed by a selected fixed input label of said characteristic; and
(d) displaying said multi-media business listing to the potential customer in response to the potential customer query to compare said geographically based selected fixed input attribute with said selected fixed input term and said non-geographically based selected fixed input characteristic with said selected fixed input label, all as matched between the business owner and the potential customer.
